(19) United States
(12) Patent Application Publication
(10) Pub. No.: US 2019/0127493 A1
(43) Pub. Date: May 2, 2019

(54) METHOD FOR EXTRACTING TREMELLA POLYSACCHARIDE WITH BUFFER SOLUTION

(71) Applicants: JIE YANG, Schaumburg, IL (US); YUANDAN YANG, FUZHOU (CN)

(72) Inventors: JIE YANG, Schaumburg, IL (US); YUANDAN YANG, FUZHOU (CN)

(21) Appl. No.: 15/870,966

(22) Filed: Jan. 14, 2018

(30) Foreign Application Priority Data
Oct. 27, 2017 (CN) 201711021626.0
Oct. 27, 2017 (CN) 201711021843.X

(51) Int. Cl. C08B 37/00; B01D 11/02; B01D 9/00; B01D 21/26; B01J 19/00

(52) U.S. Cl. CPC C08B 37/0003; B01D 11/0292; B01D 9/005; B01D 21/262; B01J 19/0013; B01J 2219/00141; B01D 2251/61; B01D 2251/70; B01J 2219/00177; B01J 2219/00121; B01D 2251/606

(57) ABSTRACT

The present invention provides a method for extracting Tremella polysaccharides by using buffer solution, which comprises the following steps: leaching Tremella powder in a buffer solution with heating to obtain the leachate; subjecting the said leachate to solid-liquid separation and obtaining the liquid component which contains Tremella polysaccharides; subjecting the said liquid component to alcohol precipitation, and the precipitate obtained is Tremella polysaccharides. According to the method of the invention, various buffer solutions can achieve the extraction rates of Tremella polysaccharides up to 33:12%, which is 3 to 4 times of that of the traditional water extraction method, and greatly improve the extraction yields of Tremella polysaccharides.

### CROSS-REFERENCE TO RELATED APPLICATIONS

This application claims priority to Chinese Patent Application No. 201711021843.X with a filing date of Oct. 27, 2017 and No. 201711021626.0 with a filing date of Oct. 27, 2017. The content of the aforementioned applications, including any intervening amendments thereto, are incorporated herein by reference.

### TECHNICAL FIELD

The invention relates to a field of plant polysaccharide extraction, in particular relates to a method of extracting Tremella polysaccharides with buffer solutions.

### BACKGROUND OF THE PRESENT INVENTION

Tremella fuciformis, also known as white fungus, is a higher fungus with the function of moisturizing and nourishing lungs, replenishing qi and harmonizing blood. Tremella polysaccharides are the main active ingredients in Tremella, and are acidic heteropolysaccharides obtained from the fruiting bodies of Tremella fuciformis. The backbone of Tremella polysaccharides consists of α-(1→43)-mannan, and the branch chains consist of glucuronic acids and xylose. Tremella polysaccharides can regulate the immune system and increase clotting time, and have bioactivities including antithrombotic, hypoglycemic, hypolipidemic, tumor-suppressing, anti-aging and anti-radiation activities. Hot water was first used to extract polysaccharides from Tremella fuciformis, since when the extraction of polysaccharides has been an important research topic.

Increasing the extraction, fate of Tremella polysaccharides is key to industry-scale production of Tremella polysaccharides. At present, hot water extraction, ultrasonic-assisted extraction, microwave-assisted extraction, extrusion-assisted extraction, enzymatic extraction, alkaline leaching as well as other methods are used to extract Tremella polysaccharides.

The cell walls of Tremella fuciformis fruiting bodies have a dense structure of interwined protein and polysaccharides, making it difficult to destroy with hot water extraction alone, thus unable to sufficiently release polysaccharides. If ultrasonic generator, microwave reaction system, pressure cooker, or other auxiliary equipment is used to extract Tremella polysaccharides, the equipment and energy costs are increased. Although enzymatic extraction requires more mild conditions, the extraction process is faced with problems such as increased viscosity of, extraction solution, filtration difficulty, increases of protein and other impurities, and enzyme costs.

### SUMMARY OF PRESENT INVENTION

In view of this, the objective of the present invention is to provide a method for extracting Tremella polysaccharides with high extraction rate, low energy consumption and low cost.

In order to achieve the above objective, the present invention provides the following technical solutions;

The present invention provides a method for extracting Tremella polysaccharides by using buffer solutions, including the following steps:

Under the condition of heating, Tremella powder is leached with a buffer solution to obtain the leachate;

The leachate is subjected to solid-liquid separation to obtain the liquid component which contains Tremella polysaccharides;

The liquid component is alcohol-precipitated, and centrifuged, and the resulting precipitate is Tremella polysaccharides.

The citric acid-sodium citrate buffer solution in step 1) has a concentration of 0.1 mol/L, pH 3.0 to 6.6, composed of citric acid and sodium citrate; the acetic acid-sodium acetate buffer solution has a concentration of 0.2 mol/L, pH 3.6 to 5.8, composed of acetic acid and sodium acetate; the citrate-phosphate buffer solution is prepared from 0.1 mol/L citric acid and 0.2 mol/L disodium hydrogen phosphate solution, pH 2.2 to 8.0; the sodium phosphate buffer solution has a concentration of 0.2 mol/L, pH 5.8 to 8.0, composed of sodium dihydrogen, phosphate and disodium hydrogen phosphate; the sodium carbonate buffer solution has a concentration of 0.1 mol/L, pH 8.6 to 10.6, composed of sodium carbonate and sodium hydrogen carbonate;

The ratio of material and water in the leaching in step 1) is 1:30-1:70 g/mL.

The means of water bath temperature in heating in step 1) is comprises direct heating, water bath heating, heating with high pressure, microwave-assisted heating, and oven heating, heating temperature is 70-100° C., and the heating time is 2-6 h.

The leachate obtained in, step 1) can be slowly cooled to room temperature (20° C.) and allowed to stand for 1224-48 h, and then leached in hot water at 80-100° C. for 2-6 h.

The solid-liquid separation method in step 2) is centrifugation at a speed of 7000-9000 rpm for 5-10 min.

Ethanol solution is used in alcohol precipitation in step 3). The concentration of ethanol solution is 85-99% (v/v); the volume ratio of liquid component and ethanol solution during alcohol precipitation is 1:3-1:5.

The alcohol precipitation time in step 3) is 8-14 h.

The centrifugation speed in step 3) is 8000 to 11000 rpm and the centrifugation time is 5 to 10 min.

The method for extracting Tremella polysaccharides described in this invention uses buffer solutions as the extraction solvent to replace the traditional water extraction, and obtains Tremella polysaccharides after alcohol precipitation. The rationale for the methodology is that polysaccharides dissolve in hot buffer solutions. The method provided by the invention has the highest Tremella polysaccharide extraction rate of 33.12% which is 3 to 4 times of that of the traditional water extraction method, therefore the extraction rate of Tremella polysaccharides is greatly improved with buffer solutions. In addition, the present invention does not require expensive instruments or reagents, such as ultrasound or subcritical conditions. It has low energy consumption and low cost.

### DETAILED DESCRIPTION OF PREFERRED EMBODIMENTS

The present invention provides a method for extracting Tremella polysaccharides with buffer solutions, which comprises the following steps: 1) aching Tremella powder in a buffer solution with heating to obtain leachate; the buffer solution comprises citric acid-sodium citrate buffer solution, acetic acid-sodium acetate buffer solution, citrate-phosphate buffer solution, sodium phosphate buffer solution, sodium carbonate buffer solution; the heating temperature for extraction is 70-100, the heating time is 2-6 h, the ratio of material to water is 1:30-1:70 g/mL; 2) the leachate is subjected to solid-liquid separation to obtain the liquid component which contain Tremella polysaccharides; 3) The liquid component is alcohol precipitated, and centrifuged and the resulting precipitate is Tremella polysaccharides.

In the present invention, there is no limitation on the source of the Tremella powder, which can be obtained by drying, crushing and sieving commercially available Tremella. Drying can be carried out according to the conventional drying method and sun drying can be used specifically. Pulverization is preferably carried out by means of a Chinese herbal medicine grinder. The size of the sieve is preferably 60-100 mesh, more preferably 80 mesh; the particle size of Tremella powder is preferably 160-260 μm, more preferably 200-220 μm.

After obtaining Tremella powder, it is mixed with a buffer solution to obtain the leachate. The citric acid-sodium citrate buffer solution in the present invention has a concentration of 0.1 mol/L, pH 3,0 to 6.6, composed of citric acid and sodium citrate; the acetic acid-sodium acetate buffer solution has a concentration of 0.2 mol/L, pH 3.6 to 5.8, composed of acetic acid and sodium acetate; the citrate-phosphate buffer solution is prepared from 0.1 mol/L citric acid and 0.2 mol/L disodium hydrogen phosphate solution, pH 2.2 to 8.0; the sodium phosphate buffer solution has a concentration of 0.2 mol/L, pH 5.8 to 8.0, composed of sodium dihydrogen phosphate and disodium hydrogen phosphate; the sodium carbonate buffer solution has a concentration of 0.1 mol/L, pH 8.6 to 10.6, composed of sodium carbonate and sodium hydrogen bicarbonate;

In the present invention, the ratio (w/v) of Tremella powder to the buffer solution is preferably 1:30 to 1:70 g/mL; more preferably 1:40 to 1:50 g/mL.

In the present invention, heating can be achieved by direct heating, water bath heating, heating with high pressure, microwave-assisted heating, oven heating, etc. the extraction is carried out in a heated water bath. The heating temperature of the water bath is 70-100° C., preferably 90-100° C.; the extraction time is 2-6 h, preferably 4-5 h. The water bath can be a conventional water bath device without any other special limitation. In the practice of the present invention, a conventional water bath or a pressure cooker can be used. During water bath incubation with heating, the buffer solution extracts Tremella polysaccharides in Tremella powder to obtain the leachate, which includes insoluble Tremella residues and soluble Tremella polysaccharides.

The leachate obtained in the present invention can also be slowly cooled to room temperature (20° C.) and allowed to stand for 1224-48 h, and then leached in hot water at 70-100° C. for 2˜5-6 h.

In the present invention, the leachate is subjected to solid-liquid separation to collect the liquid component. In the present invention, the solid-liquid separation method is preferably centrifugation; the centrifugation speed is preferably 7000 to 9000 rpm, more preferably 8000 to 9000 rpm; the centrifugation time is preferably 5 to 10 min, more, preferably 8 to 10 min. The purpose of the said solid-liquid separation in the present invention is to remove the solid residues of Tremella powder insoluble in the buffer solution to facilitate subsequent alcohol precipitation of Tremella polysaccharides.

In the present invention, after the liquid component is obtained, it is subjected to alcohol precipitation to obtain alcohol precipitated leachate which comprises the precipitated Tremella polysaccharides and the supernatant. In the present invention, the alcohol reagent used to precipitate Tremella polysaccharides is preferably ethanol; the concentration of the ethanol solution is preferably 85-99% (v/v), more preferably 90-95%; the volume ratio of the liquid component and the ethanol solution is preferably 1:3 to 1:5, and more preferably 1:4 to 1:5.

In the practice of the present invention, alcohol precipitation specifically refers to mixing of the liquid component with ethanol and incubating for precipitation. There is no particular limitation to the mixing method of the present invention as long as mixing can be achieved. In the present invention, alcohol precipitation time is preferably 8 to 14 hours, more preferably 11 to 14 hours. Precipitation of polysaccharides results from breaking of hydrogen bonds in the liquid component by ethanol and reduced solubility of Tremella polysaccharides in the liquid component.

After obtaining the alcohol precipitated leachate, a second solid-liquid separation on the leachate was performed to obtain Tremella polysaccharides. In the present invention, the second solid-liquid separation method is preferably centrifugation; the centrifugation speed is preferably 8000 to 11000 rpm, more preferably 9500 to 11000 rpm; the centrifugation time is preferably 5 to 10 min, more preferably 8 to 10 min. In the present invention, the solid precipitate is collected after the second solid-liquid separation, which is the extracted Tremella polysaccharides.

The extraction yield of Tremella polysaccharides in the invention is calculated as follows:

$$Tremella polysaccharide extraction rate = \frac{Tremella polysaccharide weight}{Tremella powder dry weight} \times 100 \% .$$

In the present invention, an aqueous solution of Tremella polysaccharides is obtained by dissolving in water Tremella polysaccharides obtained by the above-mentioned extraction. The concentration of Tremella polysaccharides in aqueous solution is determined by phenol-sulfuric acid method, and the extraction yield of Tremella polysaccharides is calculated.

The method for extracting Tremella polysaccharides provided by the present invention will be described in details below with reference to the examples, but these are not to be construed as limiting the scope of the present invention.

### EXAMPLE 1

Dry the commercially available Tremella, pulverize to fine powder and sieve by a 90-mesh, sieve. Add 40 ml citric acid-sodium citrate buffer solution at pH 3.0 to 1 g Tremella powder, and then place the mixture in a hot water bath at 100° C. After 5 h, the leachate is centrifuged at 8000 rpm for 8 min. Discard the pellet, and add 4 volumes of 90% ethanol to the supernatant. Precipitate for 12 h and centrifuge at 10000 rpm for 8 min. Remove the supernatant and obtain the precipitate of Tremella polysaccharides.

Replace the citric acid—sodium citrate buffer solution with water as the leaching solvent in the control test, and follow the method as described above.

Dissolve the precipitate of Tremella polysaccharides in 20 ml water, and the concentration of polysaccharides in the solution is determined to be 15.79 mg/ml by phenol-sulfuric acid method. The mass of polysaccharides in the polysaccharide precipitate is calculated to be 315.8 mg, and the polysaccharide extraction rate is 31.58%. The yield of Tremella polysaccharides extracted with water is 7.55%, and the buffer extraction increased the extraction yield by 318.3%.

### EXAMPLE 2

Dry the commercially available Tremella, pulverize to fine powder and sieve by an 80-mesh sieve. Add 40 ml of citric acid-sodium citrate buffer solution at pH 3.0 to 1 g of Tremella powder, and then place the mixture in a hot water bath at 100° C. After 4 h, the leachate is centrifuged at 7500 rpm for 5 min. Discard the pellet, and add 4.5 volumes of 95% ethanol to the supernatant. Precipitate for 11 h and centrifuge at 11000 rpm for 6 min. Remove the supernatant and obtain the precipitate of Tremella polysaccharides.

Replace the citric acid—sodium citrate buffer solution with water as the leaching solvent in the control test, and follow the described above.

Dissolve the precipitate of Tremella polysaccharides in 20 ml of water, and the concentration of polysaccharides in the solution is determined to be 14.35 mg/ml by phenol-sulfuric acid method. The mass of polysaccharides in the polysaccharide precipitate is calculated to be 287.0 mg and the polysaccharides extraction rate is 28.7%. The yield of Tremella polysaccharides extracted from Tremella with water is 7.35%, and the buffer extraction increased the extraction yield by 290.5%.

### EXAMPLE 3

Dry the commercially available Tremella, pulverize to fine powder and sieve by a 70-mesh sieve. Add 30 ml of citric acid-sodium citrate buffer solution at pH 3.0 to 1 g of Tremella powder, and then place the mixture in a hot water bath at 100° C. After 4 h, the leachate is centrifuged at 7000 rpm for 7 min. Discard the pellet, and add 4 volumes of 90% ethanol to the supernatant. Precipitate for 9 h and centrifuge at 11000 rpm for 5 min. Remove the supernatant and obtain the precipitate of Tremella polysaccharides.

Replace the citric acid—sodium citrate buffer solution with water as the leaching solvent in the control test, and follow the method as described above.

Dissolve the precipitate of Tremella polysaccharides in 20 ml of water, and the concentration of polysaccharides in the solution is determined to be 8.16 mg/ml by phenol-sulfuric acid method. The mass of polysaccharides in the polysaccharide precipitate is calculated to be 162.2 mg and the polysaccharides extraction rate is 16.32%. The yield of Tremella polysaccharides extracted with water is 6.22%, and the buffer extraction increased the extraction yield by 162.4%.

### EXAMPLE 4

Dry the commercially available Tremella, pulverize to fine powder and sieve by a 60-mesh sieve. Add 60 ml of citric acid-sodium citrate buffer solution at pH 3.0 to 1 g of Tremella powder, and then place the mixture in a hot water bath at 100° C. and leach in water bath. After 3 h, the leachate is centrifuged at 8000 rpm for 6 min. Discard the pellet, and add 3 volumes of 99% ethanol to the supernatant. Precipitate for 10 h and centrifuge at 9000 rpm for 9 min. Remove the supernatant and obtain the precipitate of Tremella polysaccharides.

Replace the citric acid—sodium citrate buffer solution with water as the leaching solvent in the control test, and follow the method as described above.

Dissolve the precipitate of Tremella polysaccharides in 20 ml of water, and the concentration of polysaccharides in the solution is determined to be 13.32 mg/ml by phenol-sulfuric acid method. The mass of polysaccharides in the polysaccharide precipitate is calculated to be 266.3 mg and the polysaccharides extraction rate is 26.63%. The yield of Tremella polysaccharides extracted with water is 5.62%, and the buffer extraction increased the extraction yield by 373.8%.

### EXAMPLE 5

Dry the commercially available Tremella, pulverize to fine powder and sieve by a 70-mesh sieve. Add 50 ml of citric acid-sodium citrate buffer solution at pH 3.0 to 1 g of Tremella powder, and then place the mixture in a hot water bath at 90° C. After 6 h, the leachate is centrifuged at 9000 rpm for 8 min. Discard the pellet, and add 4 volumes of 95% ethanol to the supernatant. Precipitate for 8 h and centrifuge at 10000 rpm for 10 min. Remove the supernatant and obtain the precipitate of Tremella polysaccharides.

Replace the citric acid—sodium citrate buffer solution with water as the leaching solvent in the control test, and follow the method as described above.

Dissolve the precipitate of Tremella polysaccharides in 20 ml of water, and the concentration of polysaccharides in the solution is determined to be 12.88 mg/ml by phenol-sulfuric acid method. The mass of polysaccharides in the polysaccharide precipitate is calculated to be 257.6 mg and the polysaccharides extraction rate is 25.76%. The yield of Tremella polysaccharides extracted with water is 7.95%, and the buffer extraction increased the extraction yield by 224.0%.

### EXAMPLE 6

Dry the commercially available Tremella and pulverize to fine powder and sieve by a 100-mesh sieve. Add 70 ml of citric acid-sodium citrate buffer solution at pH 3.0 to 1 g of Tremella powder, and then place the mixture in a hot water bath at 90° C. and leach in water bath. After 4 h, the leachate is centrifuged at 8000 rpm for 7 min. Discard the pellet, and add 4 volumes of 90% ethanol to the supernatant. Precipitate for 8 h and centrifuge at 11000 rpm for 7 min. Remove the supernatant and obtain the precipitate of Tremella polysaccharides.

Replace the citric acid—sodium citrate buffer solution with water as the leaching solvent in the control test, and follow the method as described above.

Dissolve the precipitate of Tremella polysaccharides in 20 ml of water, and the, concentration of polysaccharides in the solution is determined to be 12.19 mg/ml by phenol-sulfuric acid method. The mass of polysaccharides in the polysaccharide precipitate is calculated to be 243.8 mg and the polysaccharides extraction rate is 24.38%. The yield of Tremella polysaccharides extracted with water is 7.32%, and the buffer extraction increased the extraction yield by 233.1%.

### EXAMPLE 7

Dry the commercially available Tremella, pulverize to fine powder and sieve by an 80-mesh sieve. Add 50 ml of citric acid-sodium citrate buffer solution at pH 3.0 to 1 g of Tremella powder, and then place the mixture in a hot water bath at 90° C. and leach in water bath. After 4 h, the leachate is centrifuged at 9000 rpm for 6 min. Discard the pellet, and add 3 volumes of 99% ethanol to the supernatant. Precipitate for 9 h and centrifuge at 10000 rpm for 6 min. Remove the supernatant and obtain the precipitate of Tremella polysaccharides.

Replace the citric acid—sodium citrate buffer solution with water as the leaching solvent in the control test, and follow the method as described above.

Dissolve the precipitate of Tremella polysaccharides in 20 ml of water, and the concentration of polysaccharides in the solution is determined to be 6.98 mg/ml by phenol-sulfuric acid method. The mass of polysaccharides in the polysaccharide precipitate is calculated to be 139.6 mg and the polysaccharides extraction rate is 13.96%. The yield of Tremella polysaccharides extracted with water is 7.31%, and the buffer extraction increased the extraction yield by 91.0%.

### EXAMPLE 8

Dry the commercially available Tremella and pulverize to fine powder and sieve by a 70-mesh sieve. Add 50 ml of citric acid-sodium citrate buffer solution at pH 6.0 to 1 g of Tremella powder, and then place the mixture in a hot water bath at 90° C. and leach in water bath. After 4 h, the leachate is centrifuged at 8000 rpm for 5 min. Discard the pellet, and add 4 volumes of 95% ethanol to the supernatant. Precipitate for 12 h and centrifuge at 10000 rpm for 5 min. Remove the supernatant and obtain the precipitate of Tremella polysaccharides.

Replace the citric acid—sodium citrate buffer solution with water as the leaching solvent in the control test, and follow the method as described above.

Dissolve the precipitate of Tremella polysaccharides in 20 ml of water, and the concentration of polysaccharides in the solution is determined to be 8.50 mg/ml by phenol-sulfuric acid method. The mass of polysaccharides in the polysaccharide precipitate is calculated to be 170.0 mg, the polysaccharides extraction rate is 17.00%. The yield of Tremella polysaccharides extracted with water is 7.31%, and the buffer extraction increased the extraction yield by 132.6%.

### EXAMPLE 9

Dry the commercially available Tremella, pulverize to fine powder and sieve by a 90-mesh sieve. Add 50 ml of citric acid-sodium citrate buffer solution at pH 6.6 to 1 g of Tremella powder, and then place the mixture in a hot water bath at 90° C. and leach in water bath. After 4 h, the leachate is centrifuged at 8500 rpm for 9 min. Discard the pellet, and add 5 volumes of 90% ethanol to the supernatant. Precipitate for 10 h and centrifuge at 9000 rpm for 8 min. Remove the supernatant and obtain the precipitate of Tremella polysaccharides.

Replace the citric acid—sodium citrate buffer solution with water as the leaching solvent in the control test, and follow the method as described above.

Dissolve the precipitate of Tremella polysaccharides in 20 ml of water, and the concentration of polysaccharides in the solution is determined to be 10.19 mg/ml by phenol-sulfuric acid method. The mass of polysaccharides in the polysaccharide precipitate is calculated to be 203.7 mg and the polysaccharides extraction rate, is 20.37%. The yield of Tremella polysaccharides extracted with water is 7.31%, and the buffer extraction increased the, extraction yield by 178.7%.

### EXAMPLE 10

Dry the commercially available Tremella and pulverize to fine powder and sieve by an 80-mesh sieve. Add 40 ml of sodium phosphate buffer solution at pH 6.8 to 1 g of Tremella powder, and then place the mixture in a hot water bath at 100° C. and leach in water bath. After 4 h, the leachate is centrifuged at 7500 rpm for 5 min. Discard the pellet, and add 4 volumes of 95% ethanol to the supernatant. Precipitate for 11 h and centrifuge at 11000 rpm for 6 min. Remove the supernatant and obtain the precipitate of Tremella polysaccharides.

Replace the sodium phosphate buffer solution with water as the leaching solvent in the control test, following the method as described above.

Dissolve the precipitate of Tremella polysaccharides in 20 ml of water, and the concentration of polysaccharides in the solution is determined to be 9.83 mg/ml by phenol-sulfuric acid method. The mass of polysaccharides in the polysaccharide precipitate is calculated to be 196.6 mg, and the polysaccharides extraction rate is 19.66%. The yield of Tremella polysaccharides extracted with water is 7.35%, and the buffer extraction increased the extraction yield by 167.5%.

### EXAMPLE 11

Dry the commercially available Tremella, pulverize to fine powder and sieve by a 100-mesh sieve. Add 50 ml of sodium phosphate buffer solution at pH 6.8 to 1 g of Tremella powder, and then place the mixture in a hot water bath at 70° C. and leach in water bath. After 4 h, the leachate is centrifuged at 8000 rpm for 8 min. Discard the pellet, and add 4 volumes of 90% ethanol to the supernatant. Precipitate for 14 h and centrifuge at 8000 rpm for 10 min. Remove the supernatant and obtain the precipitate of Tremella polysaccharides.

Replace the sodium phosphate buffer solution with water as the leaching solvent in the control test, and follow the method as described above.

Dissolve the precipitate of Tremella polysaccharides in 20 ml of water, and the concentration of polysaccharides in the solution is determined to be 8.28 mg/ml by phenol-sulfuric acid method. The mass of polysaccharides in the polysaccharide precipitate is calculated to be 125.6 mg and the polysaccharides extraction rate is 12.56%. The yield of Tremella polysaccharides extracted with water is 4.37%. and the buffer extraction increased the extraction yield by 187.4%.

### EXAMPLE 12

Dry the commercially available Tremella, pulverize to fine powder and sieve by an 80-mesh sieve. Add 60 ml of sodium phosphate buffer solution at pH 6.8 to 1 g of Tremella powder, and then place the mixture in a hot water bath at 80° C. After 5 h, the leachate is centrifuged at 9000 rpm for 7 min. Discard the pellet, and add 4 volumes of 90% ethanol to the supernatant. Precipitate for 10 h and centrifuge at 10000 rpm for 10 min. Remove the supernatant and obtain the precipitate of Tremella polysaccharides.

Replace the sodium phosphate buffer solution with water as the leaching solvent in the control test, and follow the method as described above.

Dissolve the precipitate of Tremella polysaccharides in 20 ml of water, and the concentration of polysaccharides in the solution is determined to be 9.52 mg/ml by phenol-sulfuric acid method. The mass of polysaccharides in the polysaccharide precipitate is calculated to be 190.3 mg and the polysaccharides extraction rate is 19.03%, The yield of Tremella polysaccharides extracted with water is 7.25%, and the buffer extraction increased the extraction yield by 162.5%.

### EXAMPLE 13

Dry the commercially available Tremella, pulverize to fine powder and sieve by an 80-mesh sieve. Add 50 ml of sodium phosphate buffer solution at pH 6.8 to 1 g of Tremella powder, and then place the mixture in a hot water bath at 90° C. After 2 h, the leachate is centrifuged at 7000 rpm for 5 min. Discard the pellet, and add 3 volumes of 99% ethanol to the supernatant. Precipitate for 12 h and centrifuge at 11000 rpm for 7 min. Remove the supernatant and obtain the precipitate of Tremella polysaccharides

Replace the sodium phosphate buffer solution with water as the leaching solvent in the control test, and follow the method as described above.

Dissolve the precipitate of Tremella polysaccharides in 20 ml of water, and the concentration of polysaccharides in the solution is determined to be 7.54 mg/ml by phenol-sulfuric acid method. The mass of polysaccharides in the polysaccharide precipitate is calculated to be 150.8 mg and the polysaccharides extraction rate is 15.08%. The yield of Tremella polysaccharides extracted with water is 3.67%, and the buffer extraction increased the extraction yield by 310.9%.

### EXAMPLE 14

Dry the commercially available Tremella, pulverize to fine powder and sieve by a 100-mesh sieve. Add 70 ml of sodium phosphate buffer solution at pH 6.8 to 1 g of Tremella powder, and then place the mixture in a hot water bath at 90° C. After 4 h, the leachate is centrifuged at 8000 rpm for 7 min. Discard the pellet, and add 4 volumes of 99% ethanol to the supernatant. Precipitate for 8 h and centrifuge at 11000 rpm for 7 min. Remove the supernatant and obtain the precipitate of Tremella polysaccharides.

Replace the sodium phosphate buffer solution with water as the leaching solvent in the control test, and follow the method as described above.

Dissolve the precipitate of Tremella polysaccharides in 20 ml of water, and the concentration of polysaccharides in the solution is determined to be 14.85 mg/ml by phenol-sulfuric acid method. The mass of polysaccharides in the polysaccharide precipitate is calculated to be 298.9 mg and the polysaccharides extraction rate is 29.69%. The yield of Tremella polysaccharides extracted with water is 7.32%, and the buffer extraction increased the extraction yield by 305.6%.

### EXAMPLE 15

Dry the commercially available Tremella, pulverize to fine powder and sieve by a 60-mesh sieve. Add 50 ml of sodium phosphate buffer solution at pH 5.8 to 1 g of Tremella powder, and then place the mixture in a hot water bath at 90° C. After 4 h, the leachate is centrifuged at 700 rpm for 5 min. Discard the pellet, and add 3 volumes of 95% ethanol to the supernatant. Precipitate for 8 h and centrifuge at 9000 rpm for 10 min. Remove the supernatant and obtain the precipitate of Tremella polysaccharides.

Replace the sodium phosphate buffer solution with water as the leaching solvent in the control test, and follow the method as described above.

Dissolve the precipitate of Tremella polysaccharides in 20 ml of water, and the concentration of polysaccharides in the solution is determined to be 10.00 mg/ml by phenol-sulfuric acid method. The mass of polysaccharides in the polysaccharide precipitate is calculated to be 199.9 mg and the polysaccharides extraction rate is 19.99%, The yield of Tremella polysaccharides extracted with water is 7.31%, and the buffer extraction increased the extraction yield by 173.5%.

### EXAMPLE 13

Dry the commercially available Tremella, pulverize to fine powder and sieve by an 80-mesh sieve. Add 50 ml of sodium phosphate buffer solution at pH 7.2 to 1 g of Tremella powder, and then place the mixture in a hot water bath at 90° C. After 4 h, the leachate is centrifuged at 8000 rpm for 8 min. Discard the pellet, and add 3 volumes of 95% ethanol to the supernatant. Precipitate for 12 h and centrifuge at 10000 rpm for 8 min. Remove the supernatant and obtain the precipitate of Tremella polysaccharides.

Replace the sodium phosphate buffer solution with water as the leaching solvent in the control test, and follow the method as described above.

Dissolve the precipitate of Tremella polysaccharides in 20 ml of water, and the concentration of polysaccharides in the solution is determined to be 9.57 mg/ml by phenol-sulfuric acid method. The mass of polysaccharides in the polysaccharide precipitate is calculated to be 191.3 mg and the polysaccharides extraction rate is 19.13%. The yield of Tremella polysaccharides extracted with water is 7.31%, and the buffer extraction increased the extraction yield by 161.7%.

### EXAMPLE 17

Dry the commercially available Tremella, pulverize to fine powder and sieve by a 70-mesh sieve. Add 50 ml of sodium phosphate buffer solution at pH 7.8 to 1 g of Tremella powder, and then place the mixture in a hot water bath at 90° C. After 4 h, the leachate is centrifuged at 8000 rpm for 5 min. Discard the pellet, and add 4 volumes of 95% ethanol to the supernatant. Precipitate for 12 h and centrifuge at 10000 rpm for 5 min. Remove the supernatant and obtain the precipitate of Tremella polysaccharides.

Replace the sodium phosphate buffer solution with water as the leaching solvent in the control test, and follow the method as described above.

Dissolve the precipitate of Tremella polysaccharides in 20 ml of water, and the concentration of polysaccharides in the solution is determined to be 7.41 mg/ml by phenol-sulfuric acid method. The mass of polysaccharides in the polysaccharide precipitate is calculated to be 148.1 mg and the polysaccharides extraction rate is 14.81%. The yield of Tremella polysaccharides extracted with water is 7.31%, and the buffer extraction increased the extraction yield by 102.6%.

### EXAMPLE 18

Dry the commercially available Tremella, pulverize to fine powder and sieve by an 80-mesh sieve. Add 50 ml of citrate-phosphate buffer solution at pH 2.2 to 1 g of Tremella powder, and then place the mixture in a hot water bath at 90° C. After 4 h, the leachate is centrifuged at 9000 rpm for 8 min. Discard the pellet, and add 5 volumes of 90% ethanol to the supernatant. Precipitate for 14 h and centrifuge at 1100 rpm for 5 min. Remove the supernatant and obtain the precipitate of Tremella polysaccharides.

Replace the citrate-phosphate buffer solution with water as the leaching solvent in the control test, and follow the method as described above

Dissolve the precipitate of Tremella polysaccharides in 20 ml of water, and the concentration of polysaccharides in the solution is determined to be 12.45 mg/ml by phenol-sulfuric acid method. The mass of polysaccharides in the polysaccharide precipitate is calculated to be 249.0 mg and the polysaccharides extraction rate is 24.90%. The yield of Tremella polysaccharides extracted with water is 7.31%, and the buffer extraction increased the extraction yield by 240.6%.

### EXAMPLE 19

Dry the commercially available Tremella, pulverize to fine powder and sieve by a 90-mesh sieve. Add 50 ml of citrate-phosphate buffer solution at pH 3.0 to 1 g of Tremella powder, and then place the mixture in a hot water bath at 90° C. After 4 h, the leachate is centrifuged at 8500 rpm for 6 min. Discard the pellet, and add 3 volumes of 99% ethanol to the supernatant. Precipitate for 10 h and centrifuge at 11000 rpm for 8 min. Remove the supernatant and obtain the precipitate of Tremella polysaccharides.

Replace the citrate-phosphate buffer solution with water as the leaching solvent in the control test, and follow the method as described above.

Dissolve the precipitate of Tremella polysaccharides in 20 ml of water, and the concentration of polysaccharides in the solution is determined to be 12.27 mg/ml by phenol-sulfuric acid method. The mass of polysaccharides in the polysaccharide precipitate is calculated to be 245.3 mg and the polysaccharides extraction rate is 24.53%. The yield of Tremella polysaccharides extracted with water is 7.31%, and the buffer extraction increased the extraction yield by 235.6%.

### EXAMPLE 20

Dry the commercially available Tremella, pulverize to fine powder and sieve by an 80-mesh sieve. Add 50 ml of citrate-phosphate buffer solution at pH 8.0 to 1 g of Tremella powder, and then place the mixture in a hot water bath at 90° C. After 4 h, the leachate is centrifuged at 7500 rpm for 8 min. Discard the pellet, and add 3 volumes of 99% ethanol to the supernatant. Precipitate for 11 h and centrifuge at 9000 rpm for 8 min. Remove the supernatant and obtain the precipitate of Tremella polysaccharides.

Replace the citrate-phosphate buffer solution with water as the leaching solvent in the control test, follow the method as described above.

Dissolve the precipitate of Tremella polysaccharides in 20 ml of water, and the concentration of polysaccharides in the solution is determined to be 85 mg/ml by phenol-sulfuric acid method. The mass of polysaccharides in the polysaccharide precipitate is calculated to be 176.9 mg and the polysaccharides extraction rate is 17.69%. The yield of Tremella polysaccharides extracted with water is 7.31%, and the buffer extraction increased the extraction yield by 142.0%.

### EXAMPLE 21

Dry the commercially available Tremella, pulverize to fine powder and sieve by a 90-mesh sieve. Add 50 ml of acetic acid—sodium acetate buffer solution at pH 3.8 to 1 g of Tremella powder, and then place the mixture in a hot water bath at 90° C. After 4 h, the leachate is centrifuged at 7000 rpm for 10 min. Discard the pellet, and add 4 volumes of 95% ethanol to the supernatant. Precipitate for 10 h and centrifuge at 10000 rpm for 10 min. Remove the supernatant and obtain the precipitate of Tremella polysaccharides.

Replace the acetic acid—sodium acetate buffer solution with water as the leaching solvent in the control test, and follow the method as described above.

Dissolve the precipitate of Tremella polysaccharides in 20 ml of water, and the concentration of polysaccharides in the solution is determined to be 6.13 mg/ml by phenol-sulfuric acid method. The mass of polysaccharides in the polysaccharide precipitate is calculated to be 122.6 mg and the polysaccharides extraction rate is 12.26%. The yield of Tremella polysaccharides extracted with water is 7.31%, and the buffer extraction increased the, extraction yield by 67.72%.

### EXAMPLE 22

Dry the commercially available Tremella and pulverize to fine powder and sieve by an 80-mesh sieve. Add 50 ml of acetic acid—sodium acetate buffer solution at pH 5,8 to 1 g of Tremella powder, and then place the mixture in a hot water bath at 90° C. and leach in water bath. After 4 h, the leachate is centrifuged at 8000 rpm for 8 min. Discard the pellet, and add 3 volumes of 95% ethanol to the supernatant. Precipitate for 12 h and centrifuge at 10000 rpm for 8 min. Remove the supernatant and obtain the precipitate of Tremella polysaccharides.

Replace the acetic acid—sodium acetate buffer solution with water as the leaching solvent in the control test, following the method as described above.

Dissolve the precipitate of Tremella polysaccharides in 20 ml of water, and the concentration of polysaccharides in the solution is determined to be 9.20 mg/ml by phenol-sulfuric acid method. The mass of polysaccharides in the polysaccharide precipitate is calculated to be 184.0 mg and the polysaccharides extraction rate is 18.40%. The yield of Tremella polysaccharides extracted with water is 7.31%, and the buffer extraction increased the extraction yield by 151.7%.

### EXAMPLE 23

Dry the commercially available Tremella, pulverize to fine powder and sieve by a 100-mesh sieve. Add 50 ml of sodium carbonate buffer solution at pH 8.7 to 1 g of Tremella powder, and then place the mixture in a hot water bath at 90° C. After 4 h, the leachate is centrifuged at 9000 rpm for 10 min. Discard the pellet, and add 4 volumes of 95% ethanol to the supernatant. Precipitate for 8 h and centrifuge at 10000 rpm for 10 min. Remove the supernatant and obtain the precipitate of Tremella polysaccharides.

Replace the sodium carbonate buffer solution with water as the leaching solvent in the control test, and follow the method as described above.

Dissolve the precipitate of Tremella polysaccharides in 20 ml of water, and the concentration of polysaccharides in the solution is determined to be 7.87 mg/ml by phenol-sulfuric acid method. The mass of polysaccharides in the polysaccharide precipitate is calculated to be 157.3 mg and the polysaccharides extraction rate is 15.73%. The yield of Tremella polysaccharides extracted with water is 7.31%, and the buffer extraction increased the extraction yield by 115.2%.

### EXAMPLE 24

Dry the commercially available Tremella, pulverize to fine powder and sieve by a 60-mesh sieve. Add 60 ml of citric acid—sodium citrate buffer solution at pH 3.0 to 1 g of Tremella powder, and then place the mixture in a hot water bath at 100° C. and leach in water bath. After 3 h, slowly cool down to room temperature (20° C.) and stand for 25-48 h, and place in a hot water bath at 100° C. again for leaching. After 3 h, the leachate is centrifuged at 8000 rpm for 6 min. Discard the pellet, and add 3 volumes of 99% ethanol to the supernatant. Precipitate for 10 h and centrifuge at 9000 rpm for 9 min. Remove the supernatant and obtain the precipitate of Tremella polysaccharides.

Replace the citric acid—sodium citrate buffer solution with water as the leaching solvent in the control test, and follow the method as described above.

Dissolve the precipitate of Tremella polysaccharides in 20 ml of water, and the concentration of polysaccharides in the solution is determined to be 16.56 mg/ml by phenol-sulfuric acid method. The mass of polysaccharides in the polysaccharide precipitate is calculated to be 331.2 mg and the polysaccharides extraction rate is 33.12%. The yield of Tremella polysaccharides extracted with water is 8.03%, and the buffer extraction increased the extraction yield by 312.5%.

### EXAMPLE 25

Dry the commercially available Tremella, pulverize to fine powder and sieve by a 100-mesh sieve. Add 50 ml of sodium phosphate buffer solution at pH 6.8 to 1 g of Tremella powder, and then place the mixture in a pressure cooker at 120° C. and 103 kPa for 20 min. The leachate is then centrifuged at 9000 rpm for 10 min. Discard the pellet, and add 4 volumes of 90% ethanol to the supernatant. Precipitate for 12 h and centrifuge at 11000 rpm for 10 min. Remove the supernatant and obtain the precipitate of Tremella polysaccharides.

Replace the sodium phosphate buffer solution with water as the reaching solvent in the control test, and follow the method as described above.

Dissolve the precipitate of Tremella polysaccharides in 20 ml of water, and the concentration of polysaccharides in the solution is determined to be 16.26 mg/ml by the phenol-sulfuric acid method. The mass of polysaccharides in the polysaccharide precipitate is calculated to be 162.6 mg, and the polysaccharide extraction rate is 32.52%. The yield of Tremella polysaccharides extracted with water is 18.63%, and the buffer extraction increased the, extraction yield by 74.56%.

The above-mentioned is only the preferred method of the present invention, and it should be noted that those who are skilled in the technical field may make some improvements and modifications without departing from the principle of the present invention, and these improvements and modifications should be regarded as the protection scope of the present invention.

1. A method for extracting Tremella polysaccharides, comprising the following steps:
1) under the condition of heating, obtaining a leachate by leaching Tremella powder with a buffer solution comprising no organic solvent, wherein the temperature is kept at 70-100° C., and the heating time is 2-6 h;
2) subjecting the leachate to solid-liquid separation to obtain a liquid component; and
3) obtaining the Tremella polysaccharides by alcohol-precipitating and centrifuging the liquid component,
wherein the buffer solution is selected from a group consisting of citric acid-sodium citrate buffer solution having a concentration of 0.1 mol/L citric acid and sodium citrate, respectively, and pH of 3.0 to 6.6; acetic acid—sodium acetate buffer solution having a concentration of 0.2 mol/L citric acid and sodium citrate, respectively, and pH of 3.6 to 5.8; and sodium carbonate buffer solution having a concentration of 0.1 mol/L sodium carbonate and sodium hydrogen carbonate, respectively, and pH of 8.6 to 10.6.

2-3. (canceled)

4. The method for extracting Tremella polysaccharides according to claim 1, wherein the ratio of material vs. water in step 1) is 1:30 to 1:70 g/mL.

5. The method for extracting Tremella polysaccharides according to claim 1, wherein heating can be achieved by means comprising direct heating, water bath heating, heating with high pressure, microwave-assisted heating, or oven heating.

6. The method for extracting Tremella polysaccharides according to claim 1, wherein the solid-liquid separation in step 2) is centrifugation at a speed of 7000-9000 rpm for 5-10 min.

7. The method for extracting Tremella polysaccharides according to claim 1, wherein ethanol solution is used in the alcohol-precipitating in step 3), and its concentration is 85 to 99% (v/v); and wherein the volume ratio of liquid component and ethanol solution during alcohol precipitation is 1:3-1:5.

8. The method for extracting Tremella polysaccharides according to claim 1, wherein the time of alcohol-precipitating in step 3) is 8-14 h.

9. The method for extracting Tremella polysaccharides according to claim 1, wherein the centrifugation speed in step 3) is 8000˜11000 rpm and the centrifugation time is 5˜10 min.

10. The method for extracting Tremella polysaccharides according to claim 1, wherein step 1) further comprises slowly cooling the leachate to room temperature, allowing the leachate to stand for 24-48 h, and heating the leachate again.
